(19) United States
(12) Patent Application Publication
(10) Pub. No.: US 2024/0217377 A1
(43) Pub. Date: Jul. 4, 2024

(54) ALTERNATING CURRENT SMART CHARGING PILE AND SYSTEM

(71) Applicants: MICRO-STAR INT’L CO.,LTD., New Taipei City (TW); MSI COMPUTER (SHENZHEN) CO.,LTD., Shenzhen City (CN)

(72) Inventors: Chuan Yi LIN, New Taipei City (TW); Hong Hen LIN, New Taipei City (TW); Chi Yang LIN, New Taipei City (TW)

(73) Assignees: MICRO-STAR INT’L CO.,LTD., New Taipei City (TW); MSI COMPUTER (SHENZHEN) CO.,LTD., Shenzhen City (CN)

(21) Appl. No.: 18/380,959

(22) Filed: Oct. 17, 2023

Related U.S. Application Data
(60) Provisional application No. 63/436,065, filed on Dec. 29, 2022.

(51) Int. Cl. B60L 53/66; B60L 53/16; B60L 53/30; B60L 53/31; B60L 53/67; B60L 53/68

(52) U.S. Cl. CPC B60L 53/66; B60L 53/16; B60L 53/305; B60L 53/31; B60L 53/67; B60L 53/68

(57) ABSTRACT

An AC smart charging pile includes a charging gun, a power supply circuit, a communication transmission unit and a signal processing circuit. The power supply circuit is connected to the charging gun, and configured to provide power to the charging gun. The communication transmission unit is configured to obtain charging data from a user device or a management center. The signal processing circuit is connected to the power supply circuit and the communication transmission unit, and configured to control charging power of the power supply circuit.

### CROSS-REFERENCE TO RELATED APPLICATIONS

This non-provisional application claims priority under 35 U.S.C. § 119(a) on Patent Application No(s). 63/436,065 filed in U.S. on Dec. 29, 2022, the entire contents of which are hereby incorporated by reference.

### BACKGROUND

### 1. Technical Field

This disclosure relates to an alternating current (AC) smart charging pile and system.

### 2. Related Art

Charging piles, also known as electric vehicle supply equipment (EVSE), are used to provide power to plug-in electric vehicles. Most of the AC charging piles currently on the market used to charge electric vehicles are designed to output power at a maximum fixed current. The alternating current provided by the charging pile is provided to the on-board charger to charge the battery of the electric vehicle.

However, the design of outputting power with a maximum fixed current cannot cope with the increasingly wide range of charging needs. In addition, this design method is more likely to cause power waste and poor charging efficiency.

### SUMMARY

Accordingly, this disclosure provides an alternating current (AC) smart charging pile and system.

According to one or more embodiment of this disclosure, an AC smart charging pile includes a charging gun, a power supply circuit, a communication transmission unit and a signal processing circuit. The power supply circuit is connected to the charging gun, and configured to provide power to the charging gun. The communication transmission unit is configured to obtain charging data from a user device or a management center. The signal processing circuit is connected to the power supply circuit and the communication transmission unit, and configured to control charging power of the power supply circuit.

According to one or more embodiment of this disclosure, an AC smart charging system includes a management center and at least one AC smart charging pile each being the AC smart charging pile described above, and connected to the management center.

In view of the above description, the AC smart charging pile and system according to one or more embodiments of the present disclosure may be used to dynamically set and adjust output power of the charging pile. Accordingly, the power supply of the charging pile may be effectively managed and the current may be adapted used, to improve power usage efficiency and reducing power loss, thereby reducing the cost.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating an AC smart charging pile according to a first embodiment of the present disclosure;

FIG. 2 is a block diagram illustrating an AC smart charging pile according to a second embodiment of the present disclosure;

FIG. 3 is a block diagram illustrating an AC smart charging pile according to a third embodiment of the present disclosure;

FIG. 4 is a block diagram illustrating an AC smart charging pile according to a fourth embodiment of the present disclosure;

FIG. 5 is a block diagram illustrating an AC smart charging pile according to a fifth embodiment of the present disclosure;

FIG. 6 is a block diagram illustrating an AC smart charging pile according to a sixth embodiment of the present disclosure;

FIG. 7 is a block diagram illustrating an AC smart charging system according to an embodiment of the present disclosure; and

FIG. 8 is a flowchart illustrating operation of the AC smart charging system according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

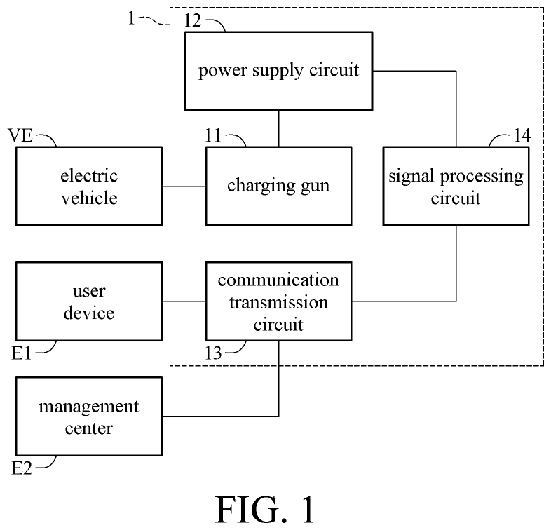

Please refer to FIG. 1, wherein FIG. 1 is a block diagram illustrating an AC smart charging pile according to a first embodiment of the present disclosure. As shown in FIG. 1, the AC (alternating current) smart charging pile 1 includes a charging gun 11, a power supply circuit 12, a communication transmission circuit 13 and a signal processing circuit 14. The charging gun 11 is connected to the power supply circuit 12. The power supply circuit 12 and the communication transmission circuit 13 are connected to the signal processing circuit 14, respectively. The term “connected to” described in the present disclosure may represent electrical connection or communication connection, the present disclosure is not limited thereto.

The charging gun 11 is controlled to provide power to an electric vehicle VE, wherein said power is, for example, alternating current, and the electric vehicle VE is, for example, an electric car. For example, the charging gun 11 may charge the electric vehicle VE based on J1772 (type 1) protocol or IEC 62196 (type 2) protocol. The power supply circuit 12 is configured to provide power to the charging gun 11. For example, the power supply circuit 12 may include a switch connected to a power source, and the power supply circuit 12 provides the power coming from the power source to the charging gun 11 when the switch is turned on.

The communication transmission circuit 13 is connected to a user device E1 in a wired or wireless way, or the communication transmission circuit 13 is connected to a management center E2 in a wired or wireless way. The communication transmission circuit 13 is configured to obtain charging data from the user device E1 or the management center E2, and transmits the charging data to the signal processing circuit 14. The user device E1 may be a smart phone, a tablet, a laptop, a desktop, or a smart watch etc. The management center E2 may be a server or a platform at the AC smart charging pile end, such as a big data management platform. The charging data may include one or more of user data (for example, user name, user account, password etc.), vehicle data of the electric vehicle VE (for example, model, remaining power etc.), designated charging period, designated power supply and start charging command. The charging data received from the user device E1 may be generated according to the user command, and the charging data received from the management center E2 may be generated according to the user command and/or user data and vehicle data of the electric vehicle VE pre-stored by the management center E2. The communication transmission circuit 13 may support one or more communication technologies, the communication technology is, for example, Bluetooth, internet module, radio frequency identification (RFID) system and near field inductive coupling (NFIC) etc., and the present disclosure is not limited thereto.

The signal processing circuit 14 is configured to read the charging data, and control the charging power of the power supply circuit 12 based on the charging data. The signal processing circuit 14 may include one or more controllers, said controller is, for example, a microcontroller, a programmable logic controller (PLC) or any other controller with signal processing function. For example, in power saving situation, if the charging data includes the user data, the signal processing circuit 14 may control the charging power according to the priority of the user, meaning the higher the user's priority, the higher the charging power corresponding to that user will be. If the charging data includes the designated charging power, the signal processing circuit 14 may control the charging power of the power supply circuit 12 according to the designated charging power. If the charging data includes the model of the electric vehicle VE, the signal processing circuit 14 may control the charging power according to the model and the corresponding rated charging power of the electric vehicle VE. If the charging data includes the remaining power of the electric vehicle VE, the signal processing circuit 14 may compare the remaining power and default power, increase the charging power when the remaining power is lower than the default power, and decrease the charging power when the remaining power is not lower than the default power. The usage scenarios described above are exemplarily, the present disclosure is not limited thereto.

The AC smart charging pile according to the first embodiment of the present disclosure may be used to dynamically set and adjust output power of the charging pile. Accordingly, the power supply of the charging pile may be effectively managed and the current may be adaptably used, to improve power usage efficiency and reducing power loss, thereby reducing charging cost.

In addition, the charging data received by the signal processing circuit 14 may have a specific transmission data structure. Specifically, the specific transmission data structure may implement unified standard protocol with specific data structure, and may include a protocol column, a security column, a function column (or an index column or a command column), a data length column, a data column, a check column and an end column. This specific transmission data structure may be used to perform information transfer and information exchange with other hardware/software units or perform setting or controlling hardware through communication units such as universal asynchronous receiver/transmitter (UART), Bluetooth element, Wi-Fi element, Ethernet element etc., thereby achieving unified standard data transfer structure. The specific transmission data structure may be as table 1 shown below, wherein each column may include one or more sub-columns. The communication interfaces listed above are merely examples, the present disclosure is not limited thereto.

TABLE 1

| | | | | | | |
|---|---|---|---|---|---|---|
| protocol | security | function | data | data | check | end |
| column | column | column | length | column | column | column |
| | | | column | | | |

The sub-column of the protocol column may include a plurality of pieces of protocol identification (ID) information and protocol values corresponding to the protocol ID information. Said protocol ID information records the charging protocols supported by the charging gun 11, and the protocol value records the protocol method for the specific transmission data structure through UART. For example, the defining characteristics of access and response represent the protocol column. The security column may record the encoding method of the specific transmission data structure, for the specific transmission data structure to not be easily decoded. The function column may record the function setting of the charging pile, for the charging pile and a machine-human interface to be able to interact with each other through the specific transmission data structure. For example, when a function of adjusting current is currently needed, the function column shows the set current. The data length column may record data length of the data column. The sub-column of the data column may include a plurality of function descriptions, a plurality of data lengths corresponding to the function descriptions and a plurality of data values corresponding to the function descriptions. For example, the function descriptions may include the charging power and charging duration supported by the charging gun 11, and the data length indicates, for example, the data length of set current values. The data value can record data describing the charging pile, including maximum charging current supported by the charging gun 11 or setting the adjustable current value of the charging gun 11. The check column may record the encoded value (for example, cyclic redundancy check). The end column may record a set of values with fixed definition, used to represent the end of the presentation of this data structure.

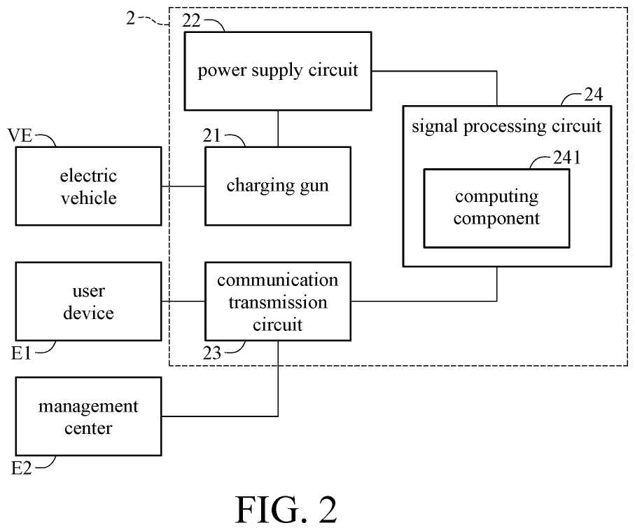

Please refer to FIG. 2, wherein FIG. 2 is a block diagram illustrating an AC smart charging pile according to a second embodiment of the present disclosure. As shown in FIG. 2, the AC smart charging pile 2 includes a charging gun 21, a power supply circuit 22, a communication transmission circuit 23 and a signal processing circuit 24. The charging gun 21 is connected to the power supply circuit 22. The power supply circuit 22 and the communication transmission circuit 23 are respectively connected to the signal processing circuit 24. The charging gun 21, the power supply circuit 22 and the communication transmission circuit 23 of the AC smart charging pile 2 are the same as the charging gun 11, the power supply circuit 12 and the communication transmission circuit 13 of the first embodiment, respectively, their repeated descriptions are omitted herein.

The signal processing circuit 24 may include a computing component 241. The computing component 241 is connected to the power supply circuit 22. The power supply circuit 22 may include a charging communication circuit which, for example, supports control pilot. The computing component 241 is, for example, the controller described above. The computing component 241 is configured to obtain a communication signal (for example, the control pilot signal) of the electric vehicle VE connected to the charging gun 21 through the power supply circuit 22, and control the charging gun 21 to charge the electric vehicle VE through the power supply circuit 22 accordingly. In other words, after the charging gun 21 is connected to the electric vehicle VE, the charging gun 21 may generate and output the communication signal to the power supply circuit 22, and the power supply circuit 22 outputs the communication signal to the computing component 241 to notify the signal processing circuit 24 to control the charging power of the power supply circuit 22 based on the charging data, and thereby controlling the power output by the charging gun 21 through the power supply circuit 22.

In addition, in the embodiment where the charging data is obtained from the management center E2, the management center E2 may store a plurality of pieces of candidate charging data, and the charging data described above may be selected from the pieces of candidate charging data. Each of the pieces of candidate charging data includes a plurality of pieces of candidate power and a plurality of candidate parameters corresponding to the pieces of candidate power, wherein the candidate parameters includes one or more of a plurality of vehicle models, a plurality of pieces of vehicle remaining power, a plurality of pieces of available charging time and a plurality of membership levels. The charging power of the power supply circuit 22 may be one of the pieces of candidate power. In other words, each of the pieces of candidate charging data corresponds to one type of parameter.

For example, the communication signal described above may indicate the model of the electric vehicle VE, the signal processing circuit 24 may, according to the model, request from the management center E2 the candidate charging data with the parameter being the vehicle model as the charging data. Assuming that the model of the electric vehicle VE is a second vehicle model, then after obtaining the charging data, the signal processing circuit 14 may determine second power corresponding to the second vehicle model, and control the charging power of the power supply circuit 22 according to the second power.

TABLE 2

| candidate power | vehicle model |
|---|---|
| first power | first vehicle model |
| second power | second vehicle model |
| third power | third vehicle model |

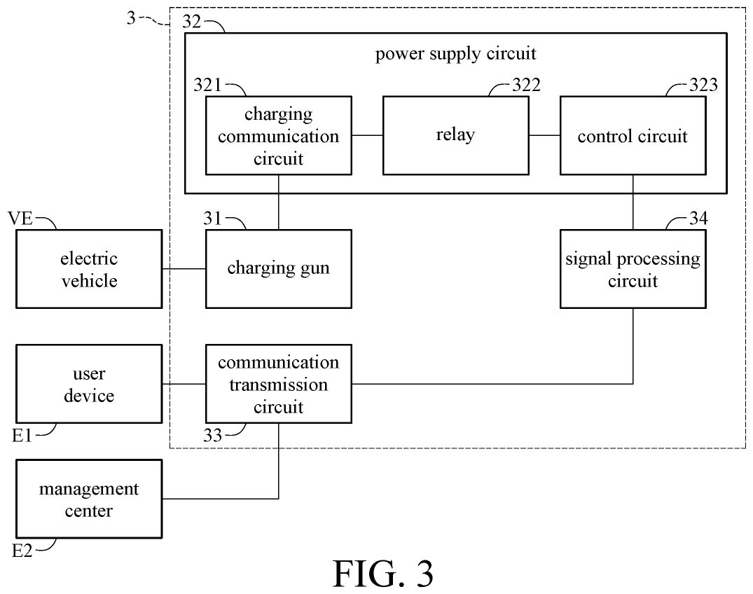

Please refer to FIG. 3, wherein FIG. 3 is a block diagram illustrating an AC smart charging pile according to a third embodiment of the present disclosure. As shown in FIG. 3, the AC smart charging pile 3 includes a charging gun 31, a power supply circuit 32, a communication transmission circuit 33 and a signal processing circuit 34. The charging gun 31 is connected to the power supply circuit 32. The power supply circuit 32 and the communication transmission circuit 33 are respectively connected to the signal processing circuit 34. The charging gun 31, the communication transmission circuit 33 and the signal processing circuit 34 of the AC smart charging pile 3 are the same as the charging gun 11, the communication transmission circuit 13 and the signal processing circuit 14 of the first embodiment, respectively, their repeated descriptions are omitted herein.

The power supply circuit 32 may include a charging communication circuit 321, a relay 322 and a control circuit 323. The charging communication circuit 321 is, for example, a circuit that supports control pilot, and is configured to be controlled by the signal processing circuit 34 to adjust the charging power corresponding to the charging gun 31. The charging communication circuit 321 analyzes (interprets) the control pilot signal through an analog to digital converter. The control pilot signal may be used to determine whether the electric vehicle VE is connected to the charging gun 31 and whether to start or stop charging. Further, the control pilot signal may indicate output frequency and duty cycle of the charging gun 31 (for example, the output frequency and the duty cycle designated by the user), so that the charging gun 31 outputs a corresponding maximum output current to the electric vehicle VE. After the charging gun 31 is connected to the electric vehicle VE, the charging gun 31 may generate and output the communication signal to the charging communication circuit 321, and the charging communication circuit 321 outputs the communication signal to the signal processing circuit 34 to notify the signal processing circuit 34 to control the charging power of the power supply circuit 32 based on the charging data. The relay 322 may be an electromagnetic relay, an induction type relay and an electronic relay etc. The relay 322 is connected to the charging gun 31 and the power source system. The relay 322 is configured to provide power coming from the power source system to the charging gun 31. The control circuit 323 is connected to the signal processing circuit 34 and the relay 322. The control circuit 323 is controlled by the signal processing circuit 34 to adjust the relay 322 to be in a disabled state or an enabled state, meaning turning on or turning off the charging gun 31. After the signal processing circuit 34 obtains the charging data, the signal processing circuit 34 controls the control circuit 323 such that the relay 322 is controlled for the charging gun 31 and the power source system to be in a conduction state (meaning the charging gun 31 is electrically connected to the power source system). Therefore, the electric vehicle VE is charged accordingly. After the signal processing circuit 34 determines that the charging is complete, the signal processing circuit 34 controls the control circuit 323 such that the relay 322 is controlled for the charging gun 31 and the power source system to be in a disconnection state (meaning the charging gun 31 is disconnected from the power source system) to stop charging the electric vehicle VE. In addition, in an embodiment where a charging pile having a plurality of charging guns, one relay may correspond to one charging gun.

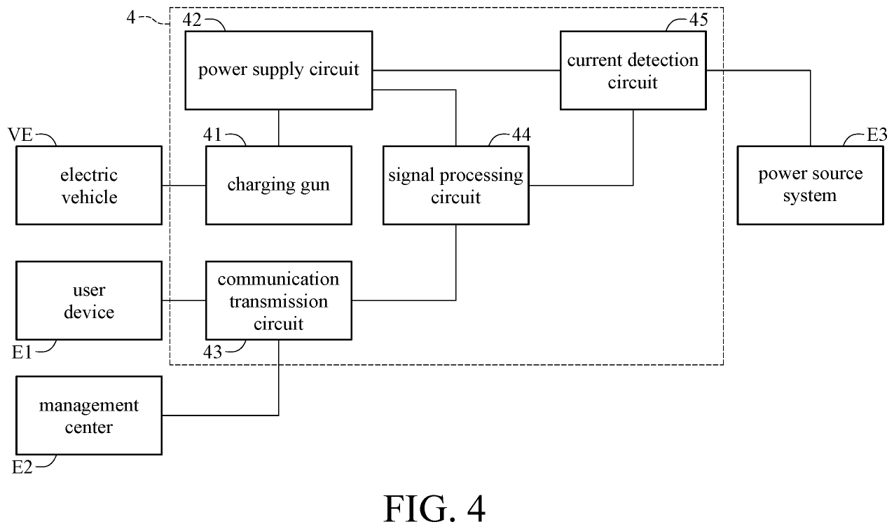

Please refer to FIG. 4, wherein FIG. 4 is a block diagram illustrating an AC smart charging pile according to a fourth embodiment of the present disclosure. As shown in FIG. 4, the AC smart charging pile 4 includes a charging gun 41, a power supply circuit 42, a communication transmission circuit 43, a signal processing circuit 44 and a current detection circuit 45. The charging gun 41 is connected to the power supply circuit 42. The power supply circuit 42, the communication transmission circuit 43 and the current detection circuit 45 are respectively connected to the signal processing circuit 44. The charging gun 41, the power supply circuit 42, the communication transmission circuit 43 and the signal processing circuit 44 of the AC smart charging pile 4 are the same as the charging gun 11, the power supply circuit 12, the communication transmission circuit 13 and the signal processing circuit 14 of the first embodiment, respectively, their repeated descriptions are omitted herein.

The current detection circuit 45 may be a sensor capable of detecting power status of an element. The current detection circuit 45 may include one or more of a galvanometer, an electric meter and a current coil. The detection signal generated by the current detection circuit 45 is converted by an analog to digital converter and then output to the signal processing circuit 44. The current detection circuit 45 is connected between the power supply circuit 42 and the power source system E3, wherein the power source system E3 may be the power source system connected to the relay 322 in the third embodiment. The current detection circuit 45 is configured to detect the charging power of the power source system E3 (i.e. the actual charging power provided to the electric vehicle VE by the power source system E3 through the power supply circuit 42), and transmit the charging power to the signal processing circuit 44. The signal processing circuit 44 adjusts the charging power of the power source system E3 through the power supply circuit 42 (for example, the charging communication circuit of the power supply circuit 42). The signal processing circuit 44 further calculates maximum charging power through detection result of the current detection circuit 45, and adjusts the charging data according to the maximum charging power.

Assuming that the maximum charging power of the power source system E3 is first power, the charging power of the charging gun 41 currently is second power, and the second power is lower than the first power, then the management center E2 may obtain the charging condition of the AC smart charging pile 4 and distribute extra power to other charging pile(s) which is at the same cite as the AC smart charging pile 4. If the required second power is not lower than the first power, the management center E2 may reduce the charging power of other charging gun(s) at the same cite. Additionally, the management center E2 may control the charging gun(s) at the same cite when there is power shortage or when the power is sufficient. For example, if the signal processing circuit 44 determines that the power of the power source system E3 is not enough according to the management center E2, the signal processing circuit 44 may determine the maximum charging power available of the power source system E3 to obtain the first power according to pre-stored data of the management center E2, and adjust the charging data according to the maximum charging power currently available to lower the second power. On the contrary, if the signal processing circuit 44 determines that the power of the power source system E3 is sufficient, the signal processing circuit 44 may determine the maximum charging power currently available of the power source system E3 to obtain the first power according to the pre-stored data of the management center E2, and adjust the charging data according to the maximum charging power currently available to increase the second power. The pre-stored data may include identification information (for example, geographical location, serial number etc.) of the AC smart charging pile 1 and the corresponding maximum charging power of the power source system E3 etc.

Accordingly, when there is power shortage, output power of one or more charging guns at the same cite as the charging pile may be adjusted to de-rate power demand; and when the power is sufficient, the output power of the charging gun(s) may be increased. Therefore, the AC smart charging pile according to one or more embodiments of the present disclosure may be used to improve usage flexibility of the charging piles.

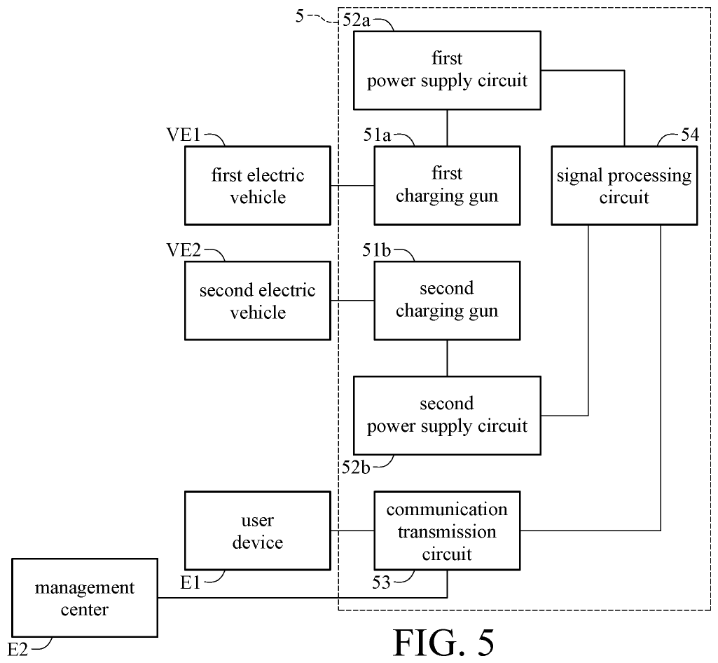

Please refer to FIG. 5, wherein FIG. 5 is a block diagram illustrating an AC smart charging pile according to a fifth embodiment of the present disclosure. As shown in FIG. 5, the AC smart charging pile 5 includes a first charging gun 51a, a second charging gun 51b, a first power supply circuit 52a, a second power supply circuit 52b, a communication transmission circuit 53 and a signal processing circuit 54. The first charging gun 51a and the second charging gun 51b are respectively connected to the first power supply circuit 52a and the second power supply circuit 52b. The first power supply circuit 52a, the second power supply circuit 52b and the communication transmission circuit 53 are respectively connected to the signal processing circuit 54. For example, the first charging gun 51a and the second charging gun 51b may support J1772 (type 1) protocol or IEC 62196 (type 2) protocol, respectively, the first charging gun 51a and the second charging gun 51b may also both support J1772 (type 1) protocol or both support IEC 62196 (type 2) protocol. The first power supply circuit 52a and the second power supply circuit 52b of the AC smart charging pile 5 may be the same as the power supply circuit 12 of the first embodiment or the power supply circuit 32 of the third embodiment, and the communication transmission circuit 53 and the signal processing circuit 54 are the same as the communication transmission circuit 13 and the signal processing circuit 14 of the first embodiment, respectively, their repeated descriptions are omitted herein. FIG. 5 illustrates two charging guns as example, the present disclosure does not limit the number of the charging gun of the charging pile. In addition, as shown in FIG. 5, the charging gun and the power supply circuit has a one-on-one relationship, that is, the number of the charging gun is the same as the number of the power supply circuit.

In the embodiment of FIG. 5, the first charging gun 51a is connected to a first electric vehicle VE1, and the second charging gun 51b is connected to a second electric vehicle VE2. The signal processing circuit 54 is further configured to control the charging power of each of the first power supply circuit 52a and the second power supply circuit 52b according to a trigger time point of each of the first charging gun 51a and the second charging gun 51b.

Take the first charging gun 51a as an example, the trigger time point may be a time point of the first charging gun 51a connected to the first electric vehicle VE1 (i.e. the time point of the signal processing circuit 54 obtaining the communication signal through the charging communication circuit of the first power supply circuit 52a), or the time point of the signal processing circuit 54 finishing the verification of the user information of the first electric vehicle VE1. The signal processing circuit 54 may increase or decrease the charging power of each of the first power supply circuit 52a and the second power supply circuit 52b according to the trigger time point of each of the first charging gun 51a and the second charging gun 51b.

For example, if a time difference between the trigger time point of the first charging gun 51a and the trigger time point of the second charging gun 51b is lower than threshold time (for example, two hours), then the signal processing circuit 54 may adjust the charging power of the first power supply circuit 52a and the second power supply circuit 52b in a power equilibrium method to control a power difference between first charging power output by the first power supply circuit 52a and second charging power output by the second power supply circuit 52b to be lower than a default error, and a sum of the two pieces of charging power is not higher than the rated charging power of the AC smart charging pile 5. Under the situation of power equilibrium, the currents output by the first power supply circuit 52a and the second power supply circuit 52b may both be, for example, 30 amperes.

If the trigger time point of the first charging gun 51a is earlier than the trigger time point of the second charging gun 51b, and the time difference between the two trigger time points is not less than first threshold time (for example, two hours) and is less than second threshold time (for example, between two to four hours), the signal processing circuit 54 may control the second charging power of the second power supply circuit 52b to be higher than the first charging power of the first power supply circuit 52a by a first preset value. For example, the first preset value is 10 amperes, an output current of the first power supply circuit 52a is 25 amperes, and an output current of the second power supply circuit 52b is 35 amperes. If the time difference is not less than the second threshold time, it means that the power shortage situation of the first electric vehicle VE1 is alleviated, and the signal processing circuit 54 may control the second charging power to be higher than the first charging power by a second preset value. For example, the first preset value is 30 amperes, the output current of the first power supply circuit 52a is 15 amperes, and the output current of the second power supply circuit 52b is 45 amperes. It should be noted that, the power parameters and time parameters described above are merely examples, and in other embodiments, the current upper limit (for example, 80 amperes) may be set based on the actual situation, and then the first preset value and the second preset value are adjusted proportionally.

If the trigger time point of the first charging gun 51a is ahead of the trigger time point of the second charging gun 51b by a time difference not less than the first threshold time, and a difference between the time difference and half of the second threshold time is smaller than another default error (for example, two hours), then the signal processing circuit 54 may control the second charging power to be higher than the first charging power by a third preset value. For example, the output current of the first power supply circuit 52a is 25 amperes, and the output current of the second power supply circuit 52b is 35 amperes.

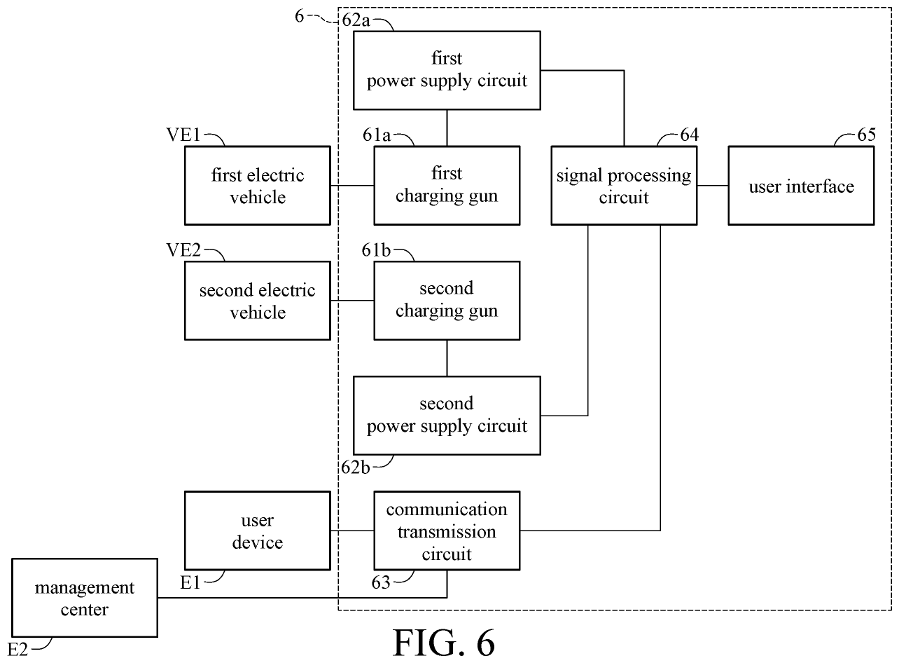

Please refer to FIG. 6, wherein FIG. 6 is a block diagram illustrating an AC smart charging pile according to a sixth embodiment of the present disclosure. As shown in FIG. 6, the AC smart charging pile 6 includes a first charging gun 61a, a second charging gun 61b, a first power supply circuit 62a, a second power supply circuit 62b, a communication transmission circuit 63, a signal processing circuit 64 and a user interface 65. The implementation and connection structure of the first charging gun 61a, the second charging gun 61b, the first power supply circuit 62a, the second power supply circuit 62b, the communication transmission circuit 63 and the signal processing circuit 64 are the same as that of the first charging gun 51a, the second charging gun 51b, the first power supply circuit 52a, the second power supply circuit 52b, the communication transmission circuit 53 and the signal processing circuit 54 of FIG. 5, their repeated descriptions are omitted herein. FIG. 6 illustrates two charging guns as an example, the present disclosure does not limit the number of the charging gun.

The user interface 65 may include one or more of a mouse, a keyboard, a camera, a touch screen and a microphone. Or a quick response (QR) code may be displayed, an external device scans the QR code for the external device to provide command to the AC smart charging pile 6. The external device is, for example, a cell phone, a tablet, a laptop etc., the present disclosure does not limit the operation of the user interface 65. The user interface 65 is connected to the signal processing circuit 64. The user interface 65 may be used to allow the user to input available staying period, display stayed period and/or charged power, wherein the available staying period indicates the available charging period (including at least one of time point and duration) of the electric vehicle. The user interface 65 may also be used for the user to perform other function settings. In the situation where the AC smart charging pile 6 is connected to a plurality of electric vehicles at the same time, the signal processing circuit 64 may further adjust the charging power of each electric vehicle according to the available staying period corresponding to each electric vehicle.

In other words, the user interface 65 is configured to receive the available staying periods corresponding to the first charging gun 61a and the second charging gun 61b, respectively. The signal processing circuit 64 is configured to increase the charging power corresponding to the shortest one among the available staying periods, and decrease the charging power corresponding to the longest one among the available staying periods. For example, assuming that the available staying period of the first electric vehicle VE1 is three hours and the available staying period of the second electric vehicle VE2 is one hour, then the signal processing circuit 64 may decrease the charging power of the first power supply circuit 62a and increase the charging power of the second power supply circuit 62b. In addition, the signal processing circuit 64 may then decrease the charging power of the second power supply circuit 62b and increase the charging power of the first power supply circuit 62a after the charging duration of the second electric vehicle VE2 or current power level equals to or is higher than a corresponding preset value (power equilibrium). Accordingly, the electric vehicle that can only stay for a short period of time may get as much power as possible.

In addition to the above embodiments, the AC smart charging pile may also be a combination of two or more of the first embodiment to the sixth embodiment.

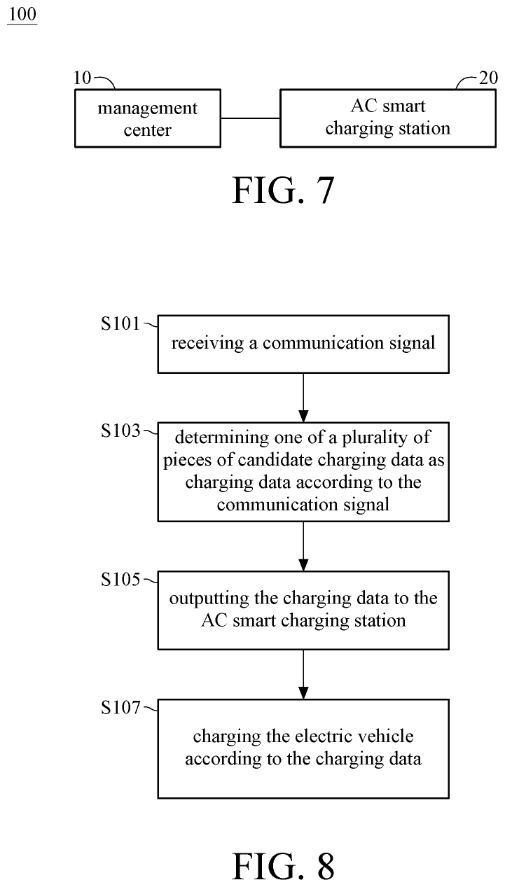

Please refer to FIG. 7, wherein FIG. 7 is a block diagram illustrating an AC smart charging system according to an embodiment of the present disclosure. The AC smart charging system 100 includes a management center 10 and at least one AC smart charging pile 20. The management center 10 is connected to the AC smart charging pile 20. The management center 10 may be the management center E2 shown in FIG. 1 to FIG. 6, and the AC smart charging pile 20 may be one of the AC smart charging piles shown in FIG. 1 to FIG. 6 or a combination or two or more of the AC smart charging piles shown in FIG. 1 to FIG. 6.

As described above, the management center 10 may store a plurality of pieces of candidate charging data. The management center 10 may obtain a corresponding relationship between the pieces of candidate power and the candidate parameters of each piece of the candidate charging data according to a plurality of pieces of history power and a plurality of history parameters. The history parameters may include history vehicle models, a plurality of pieces of history remaining power, a plurality of pieces of history available charging time and a plurality of membership levels. The history parameters indicate data of the electric vehicle charged using the AC smart charging pile 20 and/or other charging piles, and the history power indicates the charging power used by the AC smart charging pile 20 and/or other charging piles to charge the electric vehicle in the past.

For example, the management center 10 may obtain the history parameters and the corresponding history power from the AC smart charging pile 20, other charging pile, internet, user device (for example, the user device E1 of FIG. 1 to FIG. 6) and/or other databases. Take history vehicle model for example, the history vehicle model of the vehicle charged by the AC smart charging pile 20 and/or other charging piles includes a first vehicle model, a second vehicle model and a third vehicle model, each of which is used as one vehicle model in one piece of the candidate charging data. The history power corresponding to the charging of the first vehicle model, the second vehicle model and the third vehicle model may be used as the first power, the second power and the third power in the piece of the candidate charging data. Further, take the first vehicle model as an example, the first power may be an average value, a median or a mode of a plurality of pieces of history power corresponding to a plurality of the first vehicle model.

Accordingly, by performing big data analysis on history power and history parameters through the management center 10, charging efficiency of the AC smart charging pile 20 may be improved, and power of the power source system may be more effectively distributed.

Please refer to FIG. 7 and FIG. 8, wherein FIG. 8 is a flowchart illustrating operation of the AC smart charging system according to an embodiment of the present disclosure. As shown in FIG. 8, the operation of the AC smart charging system includes: step S101: receiving the communication signal; step S103: determining one of the pieces of candidate charging data as the charging data according to the communication signal; step S105: outputting the charging data to the AC smart charging pile; and step S107: charging the electric vehicle according to the charging data.

In step S101, the signal processing circuit of the AC smart charging pile 20 obtains the communication signal of the electric vehicle connected to the charging gun. The communication signal may be the control pilot signal described above. The communication signal includes a plurality of bits including protocol bit, security bit, function bit (or index bit or command bit), data length bit, data bit, check code bit and end bit etc. Therefore, the management center 10 may establish the specific transmission data structure according to the bits. In step S103, the AC smart charging pile 20 requests the charging data from the management center 10 according to the communication signal, wherein the charging data is one of the pieces of candidate charging data stored by the management center 10. Alternatively, the AC smart charging pile 20 may output the communication signal to the management center 10, and the management center 10 determines one of the pieces of candidate charging data as the charging data according to the communication signal. In step S105, the management center 10 outputs the charging data to the AC smart charging pile 20, and the communication transmission circuit of the AC smart charging pile 20 transmits the charging data to the signal processing circuit. In step S107, the signal processing circuit of the AC smart charging pile 20 charges the electric vehicle connected to the AC smart charging pile 20 according to the charging data. Specifically, as described above, the charging data may include the user data, the designated charging power, the model of the electric vehicle VE, the remaining power of the electric vehicle VE etc. The signal processing circuit may control the charging power of the power supply circuit according to the charging data, or associated hardware attribute record, including accurate calibration value of electric meter, but is not limited thereto. Therefore, the management center may perform quality associated big data analysis, wherein the details are not described herein.

Further, in addition to the signal processing circuit of the AC smart charging pile 20, the management center 10 may also calculate the maximum charging power according to detection result of the current detection circuit, and adjust the charging data according to the maximum charging power.

In view of the above description, the AC smart charging pile and system according to one or more embodiments of the present disclosure may be used to dynamically set and adjust output power of the charging pile. Accordingly, the power supply of the charging pile may be effectively managed and the current may be adaptably used, to improve power usage efficiency and reducing power loss, thereby reducing the charging cost. Further, when there is power shortage, output power of one or more charging guns at the same cite as the charging pile may be adjusted to de-rate power demand; and when the power is sufficient, the output power of the charging gun(s) may be increased. Therefore, the AC smart charging pile and system according to one or more embodiments of the present disclosure may be used to improve usage flexibility of the charging piles.

What is claimed is:

1. An alternating current (AC) smart charging pile, comprising:
a charging gun;
a power supply circuit connected to the charging gun, and configured to provide power to the charging gun;
a communication transmission unit configured to obtain charging data from a user device or a management center; and
a signal processing circuit connected to the power supply circuit and the communication transmission unit, and configured to control charging power of the power supply circuit.

2. The AC smart charging pile according to claim 1, wherein the charging data has a specific transmission data structure.

3. The AC smart charging pile according to claim 1, wherein the signal processing circuit comprises:
a computing component connected to the power supply circuit, and configured to obtain a communication signal of an electric vehicle connected to the charging gun, and control the charging gun to charge the electric vehicle according to the communication signal.

4. The AC smart charging pile according to claim 1, wherein the power supply circuit comprises:
a charging communication circuit connected to the charging gun, and configured to obtain a communication signal of an electric vehicle connected to the charging gun, and control the charging gun to charge the electric vehicle according to the communication signal;
a relay connected to the charging communication circuit, and configured to provide power from a power source system to the charging gun; and
a control circuit connected to the signal processing circuit, and controlled by the signal processing circuit to adjust the relay to be in a disabled state or an enabled state.

5. The AC smart charging pile according to claim 1, further comprising a current detection circuit connected to a power source system, the signal processing circuit further configured to calculate a maximum charging power through the current detection circuit, and adjust the charging data according to the maximum charging power.

6. The AC smart charging pile according to claim 1, wherein the charging data is obtained from the management center and is selected from a plurality of pieces of candidate charging data, each of the plurality of pieces of candidate charging data comprises a plurality of pieces of candidate power and a plurality of candidate parameters corresponding to the plurality of pieces of candidate power, wherein the plurality of candidate parameters comprise one or more of a plurality of vehicle models, a plurality of pieces of vehicle remaining power, a plurality of pieces of available charging time and a plurality of membership levels,
wherein the charging power is one of the plurality of pieces of candidate power.

7. The AC smart charging pile according to claim 6, wherein the signal processing circuit comprises:
a computing component connected to the power supply circuit, and configured to obtain a communication signal of an electric vehicle connected to the charging gun through the power supply circuit, and output the communication signal to the management center for the management center to determine one of the plurality of pieces of candidate charging data as the charging data according to the communication signal.

8. The AC smart charging pile according to claim 1, wherein the charging gun is a plurality of charging guns, the power supply circuit is a plurality of power supply circuits, the plurality of charging guns are connected to the plurality of power supply circuits, respectively, the signal processing circuit is configured to control the charging power of the respective one of the plurality of power supply circuits according to a trigger time point of each of the plurality of charging guns.

9. The AC smart charging pile according to claim 1, wherein the charging gun is a plurality of charging guns, the power supply circuit is a plurality of power supply circuits, and the AC smart charging pile further comprises:
a user interface connected to the signal processing circuit, the user interface receiving a plurality of available staying periods corresponding to the plurality of charging guns, respectively,
wherein the signal processing circuit is configured to increase the charging power of a shortest one of the plurality of available staying periods, and lower a longest one of the plurality of available staying periods.

10. An AC smart charging system, comprising:
a management center; and
at least one AC smart charging pile each being the AC smart charging pile according to claim 1, and connected to the management center.

11. An AC smart charging system, comprising:
a management center; and
at least one AC smart charging pile each being the AC smart charging pile according to claim 2, and connected to the management center.

12. An AC smart charging system, comprising:
a management center; and
at least one AC smart charging pile each being the AC smart charging pile according to claim 3, and connected to the management center.

13. An AC smart charging system, comprising:
a management center; and
at least one AC smart charging pile each being the AC smart charging pile according to claim 4, and connected to the management center.

14. An AC smart charging system, comprising:
a management center; and
at least one AC smart charging pile each being the AC smart charging pile according to claim 5, and connected to the management center.

15. An AC smart charging system, comprising:
a management center; and
at least one AC smart charging pile each being the AC smart charging pile according to claim 6, and connected to the management center.

16. An AC smart charging system, comprising:
a management center; and
at least one AC smart charging pile each being the AC smart charging pile according to claim 7, and connected to the management center.

17. An AC smart charging system, comprising:
a management center; and
at least one AC smart charging pile each being the AC smart charging pile according to claim 8, and connected to the management center.

18. An AC smart charging system, comprising:
a management center; and
at least one AC smart charging pile each being the AC smart charging pile according to claim 9, and connected to the management center.
